(19) United States
(12) Patent Application Publication
(10) Pub. No.: US 2006/0027308 A1
(43) Pub. Date: Feb. 9, 2006

(54) Method and apparatus for curing patches on composite structures having complex substrates

(76) Inventor: M. Scott MacKenzie, Ottawa (CA)

Correspondence Address: Fincham McFadden;Suite 606, 225 Metcalfe Street, Ottawa, ON, K2P 1P9, CA

(21) Appl. No.: 10/911,595

(22) Filed: Aug. 5, 2004

(51) Int. Cl. B32B 43/00

(52) U.S. Cl. 156/94

(57) ABSTRACT

In a method and apparatus for repairing a metal or composite structure such as an aircraft component wherein the component is repaired utilizing a heat spreader or caul plate and heat is applied to the caul plate or through the heat spreader to a repair whereby the component placed in operative relationship to the heat spreader or caul plate is heated to a desired and non-uniform temperature, the improvement comprising applying differential heat to the caul plate or through the heat spreader utilizing a plurality of spaced-apart heaters, and controlling the temperature of each of the plurality of heaters independently from each other to achieve a substantially uniform heat temperature applied to in the component being prepared, and the caul plate is a sheet of material capable of exhibiting superplasticity and is removed after the repair has been effected.

### FIELD OF THE INVENTION

The field of the present invention relates to a method and apparatus for repairing structures. More particularly, the present invention is directed to reliably curing patches on composite structures having complex geometric substrates.

### BACKGROUND

There are many methods for curing patches on composite structures which are generally well known in the aerospace, transportation and other industries. The main difficulty with conventional methods of curing a patch on a complex geometric substrate is inadequate control of the curing parameters such as temperature, and time at a specific temperature. Failure to control these parameters during repair of a component or structure results in voids, cracks or subsequent delamination in the repaired structure, e.g. the structural integrity of the component is not restored, due to over or under heating, or the like. Thus significant expense and level of skill to effect repairs are generally required.

One known method for curing patches of non-composite components or structures involves the use of a heat blanket. Heat blankets come in standard fixed sizes and have various shapes such as square, circular or other linear configurations. However, a heat blanket is generally not desirable for composite component applications. Standard blankets provide a uniform heat density across the blanket resulting in a parabolic-like temperature response across the surface of composite structure and the patch rather than a uniform temperature. This uniform heat density across the surface of the heater blanket typically results in a very much smaller acceptable heat zone on the structure when compared with the size of the blanket required to provide this reduced target area, resulting in an inefficient heating apparatus for the adhesives commonly used. Use of such heat blankets also tends to result in heating of a large band or zone of the structure at the outer perimeter of the blanket. The heated zone may contain moisture or oils that can vapourize causing de-lamination resulting in an increase in the size required to be repaired. Additionally, heat blankets, like any non-elastic sheet, bend in only one direction—attempting to bend in more than one direction can result in damage to the internal heating wires, (such as crumpling or breaking and/or buckling of the sheet form) thus bridging the heat across the surface of the structure. Such “heat spots” can result in cool spots which is unacceptable for curing the epoxy. While it is possible to obtain customized heater blankets which conform or are molded to a specific area or configuration to be repaired, customized blankets require significant delay of the repair while awaiting production of the blanket, are expensive and may not be useful for subsequent repairs.

A further difficulty arises from the fact that structures or component parts are increasingly being composed of composite materials known to inadequately distribute heat. In some instances, further damage is caused to the repair component due to over heating or portions of the repair area.

A known method of repairing localized damage to a composite structure is taught by U.S. Pat. No. 4,652,319, Hammond, issued on Mar. 24, 1987. Hammond uses a cup-shaped oven which includes “accordion like sides”. A conventional composite epoxy is applied to the surface to be repaired before a vacuum bag is placed over the area to apply approximately 14 psi of pressure. Hammond teaches that the oven can be placed over the repair area in order that convected hot air be applied to the repair surface resulting in minimized temperature variation over the area. Although Hammond discloses that a curved surface can be accommodated by the oven, it is clear that complex geometries could not be accommodated by such a method. Further, the necessity of manufacturing several sizes of ovens for varying surface areas would still be required.

Another method contemplated for curing a conventional epoxy on a composite structure is U.S. Pat. No. 6,031,212, Westerman et al, issued Feb. 29, 2000. Westerman et al, teaches a heating element in contact with a conductive fluid contained within a thermal bladder to deliver a substantially even thermal heating of the repair area.

Similar to the use of heater blankets, such a method would not be beneficial for complex geometries. Even very thin bladder material (preferably silicone) will buckle and cause conditions of bridging and contact loss between the heater and structure as well the bladder can break or result in the breaking of the heating element. If the material is thick it tends to form bridging effects when attempted to conform to a complex understructure resulting in the undesirable uneven heating of the structure.

There is a need for a simple process for reliably repairing structures or components having complex geometries and made of composite materials which is simple and cost-effective and which results in uniform temperature to the structure being repaired.

### SUMMARY OF THE INVENTION

According to one aspect of the present invention, there is provided a method of repairing an aircraft component wherein the component is repaired utilizing a heat spreader or caul plate and heat is applied to the caul plate or through the heat spreader to a repair whereby the component placed in operative relationship to the heat spreader or caul plate is heated to a desired and non-uniform temperature, the improvement comprising applying differential heat to the caul plate or through the heat spreader utilizing a plurality of spaced-apart heaters, and controlling the temperature of each of said plurality of heaters independently from each other to achieve a substantially uniform heat temperature applied to in the component being prepared.

It is preferable that the caul plate is a sheet of material capable of exhibiting superplasticity and is removed after the repair has been effected, the heat spreader is employed in a step of curing repair adhesives in a repair to the component and the method is carried out utilizing a superplastic heat spreader and includes the further steps of rendering the superplastic heat spreader rigid by employing a rigidizing member such as a composite fiber/tooling resin backing to form a rigid caul plate with a thermally conductive heat spreader.

In another embodiment of the invention, there is provided a method of repairing an aircraft component, comprising the steps of providing a component to be repaired, forming a heat spreader or caul plate in operative relationship to said component to be repaired, and applying said spreader to said component, said step of forming said heat spreader including:
a) sizing and positioning a layer of a superplastic material capable of exhibiting superplasticity in an operative positional relationship relative to said component to be repaired to thereby cover an area of the component to be repaired; and
b) applying heat and pressure to said layer of superplastic material to thereby place said layer in juxtaposition relative to the area of the component to be repaired, said heat being applied by differentially heating spaced-apart areas of said layer of material utilizing a plurality of independently controllable heaters and with heat being selectively applied to said layer by said independent heaters to a desired degree in order to permit said layer to substantially conform to the contours of said component provide differential heating to different areas of said layer and thus to said component to achieve a substantially uniform temperature of the component.

Desirably, in the above embodiment, the caul plate is removed after repair of the component has been completed, the heat is applied by applying perimeter heat to the layer of material and heating the material internally of the perimeter of the layer of material, the heat and pressure are applied to an extent sufficient to deform the layer of material which is capable of exhibiting superplasticity, without buckling of the component and includes the further step of casting a ceramic splash of the geometry prior to effecting step (a).

It is further desirable there is provided the further step of casting a splish.

In further embodiment of the present invention there is provided a method of repairing a metal or composite structure, such as a primary or secondary aircraft component, the improvement comprising:
a) positioning a caul member over an area of metal or composite structure to be repaired, said caul member having a desired geometry for effecting said repair and being formed of a superplastic metal capable of effecting said repair;
b) applying non-uniform heat to said caul member for generating a substantially uniform heat temperature pattern to said structure; and
c) applying pressure to said caul member to place said caul member in juxtaposition with said metal or composite structure to be repaired, said pressure being insufficient to cause buckling.

In another further embodiment of the present invention there is provided a method of manufacturing a composite structure, such as a primary or secondary aircraft component, the improvement comprising:
a) providing a molding tool having a cavity and heat elements positioned in operative relationship relative to said molding tool for heating said molding tool,
b) providing a metal having superplastic properties lined relative to said molding tool,
c) positioning a preformed composite material within said cavity of said molding tool,
d) heating said composite material uniformly to form a desired composite structure, and
e) removing said pressure and said formed composite structure from said molding tool.

It is preferable the heat is shaped heat that is conformed or defined by the shape of the heat spreader and the heat is applied by applying perimeter heat to said layer of material and sequentially heating said perimeter and material internally of the perimeter of said layer of material.

It is preferable in any of the above embodiments the layer of material is applied to a component to be repaired, the layer of material being sized to overlap the perimeter area of the component to be repaired and the layer of material comprises zinc or a zinc alloy.

In a further embodiment of the present invention, there is provided a system for effecting a repair to a component having planar or complex geometries, the system comprising:
a sheet of a metal capable of exhibiting superplasticity, said sheet being adapted for positioning in an overlapping relationship over an area of said structure to be repaired;
a plurality of spaced apart heating means capable of applying non-uniform heat to said metal sheet, said heating means adapted to generate a substantially uniform heat within the part to be repaired;
pressure means adapted to apply pressure to said area and said metal for forcing said metal into juxtaposition with said area to be repaired, said heating means and said pressure means being adapted to deform said metal against said area to be repaired.

Desirably, the sheet of metal is selected from the group consisting of zinc, zinc alloys, aluminum, the heating means includes a plurality of independently controllable heating members, the heating members are positionable to correspond to the geometry of the component to be repaired, the heating members comprise temperature sensors and the heating members are operatively associated with the vacuum source, and the pressure means is a vacuum pressure means or means for creating a pressurized atmosphere.

### BRIEF DESCRIPTION OF THE DRAWINGS

FIG. 1 illustrates a side cross sectional view of a tool or a “good” part for repair and the conformance of a superplastic to a tool after heat application;

FIG. 2 illustrates a side view of a structure having a surface with a complex geometry;

FIG. 3 illustrates a side view of a repair apparatus positioned over the surface shown in FIG. 2 before the repair has been completed;

FIG. 4 illustrates a side view of a repair apparatus positioned over the surface shown in FIG. 2 after the repair has been completed;

FIG. 5 illustrates a rigidized repair apparatus before the cure of repair;

FIG. 6 illustrates rigidized repair apparatus after a repair after the bag is removed; and,

FIG. 7 illustrates various heating arrangements to obtain uniform shaped heat.

Having thus generally defined the present invention reference will now be made to the accompanying drawings and their preferred embodiments.

### DETAILED DESCRIPTION OF THE DRAWINGS

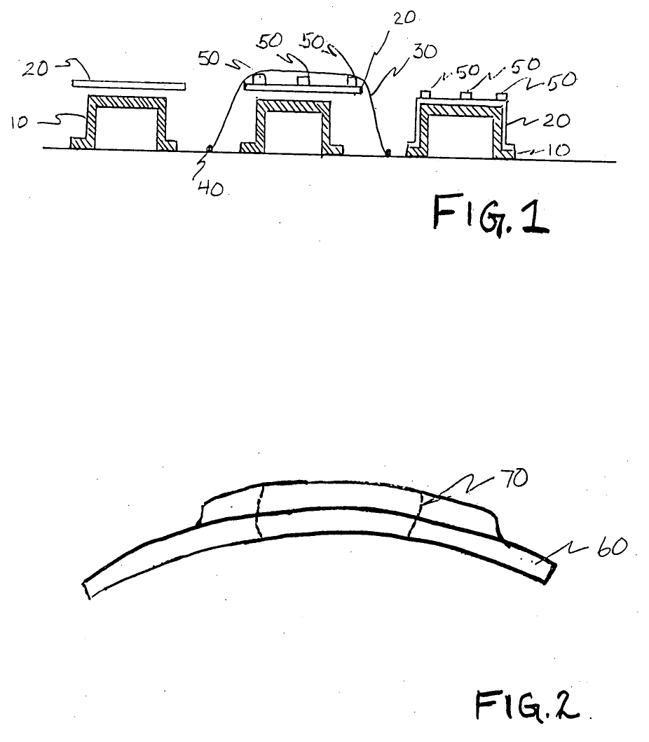

With reference to FIG. 1, a tool 10 (or ‘good’ part with geometry required) is provided which has an identical surface geometry to the component part to be repaired but without damage. A metal material 20 is cut to the desired size and shape of the repair area and is selected to as to exhibit superplastic properties. Examples of metal materials can be selected from zinc or a zinc alloy. These materials are typically commercially available in sheet form and can be readily cut to a size.

The metal material 20 is placed and taped over the area or the analogous area of the tool or mold 10. A standard high temperature vacuum bag material 30 is positioned over the metal material 20 and fitted by conventional vacuum bagging tape 40. Preferably, the vacuum bag 30 is sized to extend outwardly from the edge of the metal 20 to prevent the bag 30 from moving between the metal and the tool when vacuum is applied.

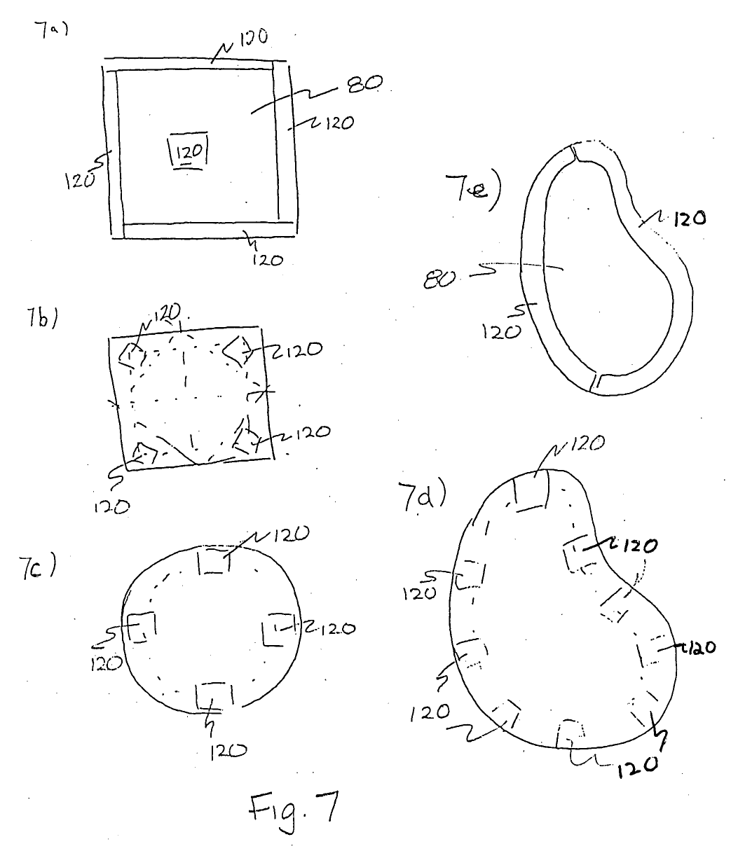

Perimeter and internal heaters 50 are applied to the bag 30 or under the bag in direct or indirect contact with the metal 20 in a contiguous or discrete manner (see FIGS. 7a to 7e) and can be held in place with adhesives, by way of vacuum or other commonly known techniques. Perimeter heaters can be of any known conventional type such as Minco strip heaters and Zimac Cells. Heat and pressure is applied to the metal material 20 in a controlled manner so that the material, having superplastic properties, gradually conforms to the shape of the tool or “good part” 10. The metal material 20 can be used as a preformed heat spreader or caul plate for the component part to be repaired.

It is also contemplated in the present invention that instead of perimeter and internal heaters an oven may be used to heat the superplastic while under vacuum pressure as described above to form the heat spreader in preparation for a repair. In further preparation of the heat spreader for obtaining uniform heat during the repair perimeter and internal heaters 50 are applied to the bag or under the bag in direct or indirect contact with the metal 20.

Desirably, the metal material 20 is sized so that the preformed heat spreader or caul plate material 20 overlaps the repair area or tooled new part by one inch. Preferably the material is approximately 0.06 to 0.09 inches thick. It should be understood that the thickness to be used is determined by the application.

It will be well understood by those skilled in the art that preforming of the material 20 into a heat spreader or caul plate as described above can also be completed during the repair of the component part (depending on heating requirements, etc.) as set out below.

We now refer to FIG. 2 which shows a portion of a typical component part 60, such as a jet engine caul, which includes an area 70 to be repaired. The substrate of the area 70 to be repaired having a curved configuration.

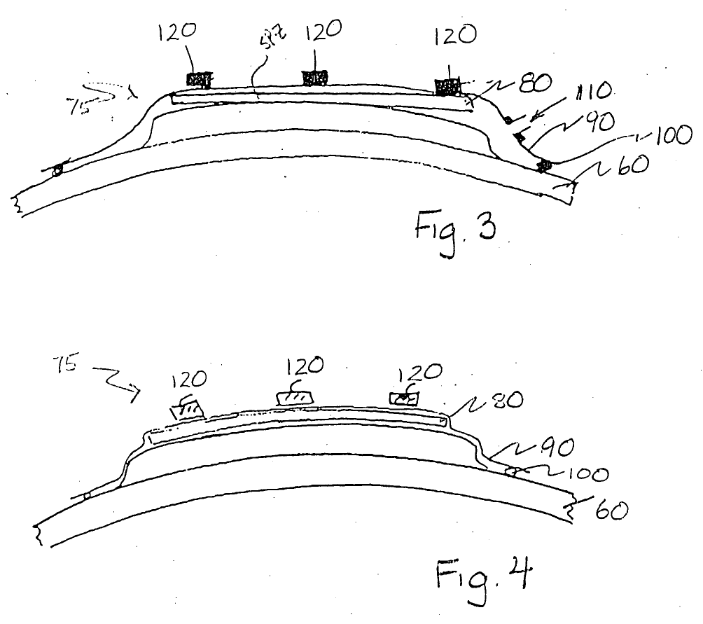

The repair apparatus 75 of the present invention is shown in FIG. 3 and FIG. 4 which illustrates a heat spreader or caul plate 80 positioned over the component part 60, generally analogous to the repair area. In a similar manner set out above, a conventional vacuum bag 90 is placed, fitted and sealed over the heat spreader or caul plate 80. Heaters 120 are positioned over the vacuum bag 90 in indirect contact with the heat spreader or caul plate 80. Preferably, the heat spreader or caul plate is a superplastic material such as Copper 0.4 to 0.6%, Aluminum 21 to 23% magnesium 0.008 to 0.012% Titanium 0.020 to 0.040% with the remainder as zinc by weight. Buckling should be avoided (remove insulation intermittently to view progress, if possible) by slow progression of pressure and enable the SPZ forming to catch up

Heat and pressure is applied to the superplastic 80. The heat is raised from ambient at standard rates of 5 degrees per minute until 200 to 250F. The pressure (vacuum) is then increased slowly to 1 atmosphere as to prevent buckling (approximately 5 in Hg per minute) and to enable the SPZ to conform to the good part.

It will be known in the art of forming superplastics that in cases of complex geometry or tight radii increased pressures and increased temperatures as high as 600F and 150 psi, such as can be achieved in special chambers, for example an autoclave, with ancillary hardware to clamp the superplastic such that sufficient stretch forming over the good part is achieved whereas simple geometry can be formed at as low as 200F and 1 atmosphere). FIG. 4 illustrates a fully formed heat spreader on the composite component part.

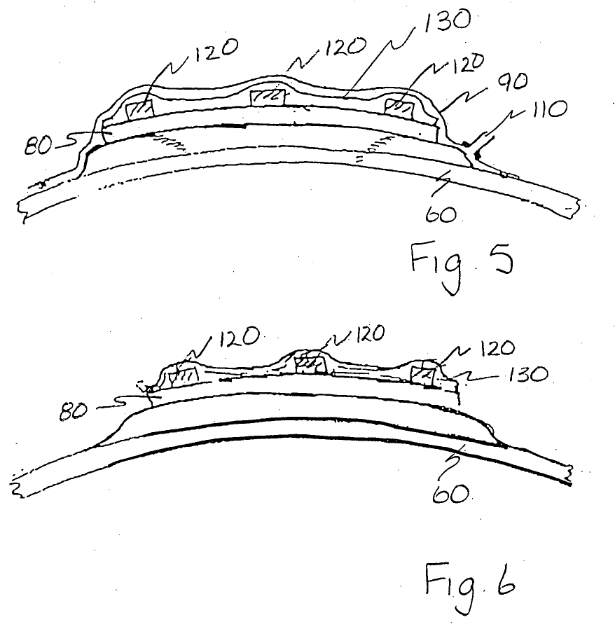

Turning now to FIG. 5 and FIG. 6 an alternate use of the apparatus would involve a rigid caul geometry to hold shape in subsequent heating. This is done using a wet lay up of standard tooling resins curable at 140 to 150F. The glass fiber is cut to fit over the SPZ and to contain the heaters. Sufficent thickness is applied for the size of the caul plate. Low temperature resin is applied to the fibers using standard processes and subsequently cured using the heaters or heat lamps to obtain first stage rigid caul plate. The second stage or final rigid form is obtained by following what is termed a post cure (for example 250 or 350F). Final temperature is achieved with standard typically very low ramp rates of 1 degree F. per minute to form the stiffening agent of the caul plate.

In situations where more heat than 250F or 350F is required (when more shape complexity is required) a good part can not be used to effect the caul or the heat spreader. In these situations a standard industry ‘splash’ followed by ‘splish’ technique from a higher temperature material would be used to obtain the so called good part to form the superplastic. Once made the ‘splish’ would be used to obtain the heat spreader. Making the heat spreader form into a rigid caul like structure would be the same as described herein above.

To complete a repair with a caul plate, standard vacuum bagging procedures using caul plates is followed using the rigid heat spreader 130 as a tool to hold shape and provide uniform heat to a repair patch as shown in FIG. 5 and FIG. 6.

Alternate arrangements to obtain uniform heat include discrete heaters or serpentine or molded heaters shown around the perimeters in FIG. 7(a) to 7(e).

The shaped heat, with uniform profile temperature in the structure, is provided by non-uniform heat application to the heat spreader or caul plate as shown in FIG. 7(a). Heat is applied around the perimeter in 1-inch wide strips with a discrete source, for example 2 inches by 2 inches at 120 to 200 watts, in the centre. It is to be understood that sizes may vary such as using a heat spreading square having a 16-inch side can be achieved. It has been found that a power density over the spreader or caul of at least 1 watt per square inch provided by the strip heaters is typically sufficient whereas larger areas are achieved by repeating this square or by successive square rings around the previous ring spaced from the previous. The, shaped uniform heat, is measured typically 1 inch in (on the structure) from the boundary edge of the spreader.

It is also contemplated by the present invention to provide a uniform heat spreader to a rigid tool for manufacturing composites. In this case the mold tool is rigid and requires heat to be injected to the mold tool such that the mold surface provides uniform temperature for curing the new part.

Heaters are applied to the heat spreader and controlled by industry standard multi-zone controllers. The number of zones required may be determined by standard industry tests of the tool or by analysis of the heat conduction of the tool.

This allows the cured part to be in contact with an analogous or like material (composite) that expands at the same CTE (coefficient of expansion) as the cured material. This ensures the molded part does not have any ‘induced stresses’ that would warp the part when it cools.

Although reference to the preferred embodiment herein pertains generally to the aerospace industry, it is to be understood that other applications are contemplated by the inventor such as wind turbine blades, transportation structures such as airplanes, marine vessels, truck bodies, submarines, racing cars etc.

1. In a method of repairing an aircraft component wherein the component is repaired utilizing a heat spreader or caul plate and heat is applied to the caul plate or through the heat spreader to a repair whereby the component placed in operative relationship to the heat spreader or caul plate is heated to a desired and non-uniform temperature, the improvement comprising applying differential heat to the caul plate or through the heat spreader utilizing a plurality of spaced-apart heaters, and controlling the temperature of each of said plurality of heaters independently from each other to achieve a substantially uniform heat temperature applied to in the component being prepared.

2. A method as defined in claim 1, wherein the caul plate is a sheet of material capable of exhibiting superplasticity and is removed after the repair has been effected.

3. A method of repairing an aircraft component, comprising the steps of providing a component to be repaired, forming a heat spreader or caul plate in operative relationship to said component to be repaired, and applying said spreader to said component, said step of forming said heat spreader including:
sizing and positioning a layer of a superplastic material capable of exhibiting superplasticity in an operative positional relationship relative to said component to be repaired to thereby cover an area of the component to be repaired; and
applying heat and pressure to said layer of superplastic material to thereby place said layer in juxtaposition relative to the area of the component to be repaired, said heat being applied by differentially heating spaced-apart areas of said layer of material utilizing a plurality of independently controllable heaters and with heat being selectively applied to said layer by said independent heaters to a desired degree in order to permit said layer to substantially conform to the contours of said component provide differential heating to different areas of said layer and thus to said component to achieve a substantially uniform temperature of the component

4. A method as defined in claim 3, wherein said caul plate is removed after said repair of said component has been completed.

5. A method as defined in claim 1, wherein said heat spreader is employed in a step of curing repair adhesives in a repair to said component.

6. A method as defined in claim 1, wherein said method is carried out utilizing a superplastic heat spreader.

7. A method as defined in claim 6, said method including the step of rendering the superplastic heat spreader rigid by employing a rigidizing member such as a composite fiber/tooling resin backing to form a rigdid caul plate with a thermally conductive heat spreader.

8. A method as defined in claim 3, wherein said heat is applied by applying perimeter heat to said layer of material and heating said material internally of the perimeter of said layer of material.

9. A method as defined in claim 3, wherein said heat and pressure are applied to an extent sufficient to deform said layer of material which is capable of exhibiting superplasticity, without buckling of said component.

10. A method as defined in claim 3, including the further step of casting a ceramic splash of the geometry prior to effecting step (a).

11. A method as defined in claim 10, including the further step of casting a splish.

12. A method as defined in claim 3, wherein the layer of material is applied to a component to be repaired, said layer of material being sized to overlap the perimeter area of the component to be repaired.

13. A method as defined in claim 3, wherein said layer of material comprises zinc or a zinc alloy.

14. In a method of repairing a metal or composite structure, such as a primary or secondary aircraft component, the improvement comprising:
a) positioning a caul member over an area of metal or composite structure to be repaired, said caul member having a desired geometry for effecting said repair and being formed of a superplastic metal capable of effecting said repair;
b) applying non-uniform heat temperature to said caul member for generating a substantially uniform heat pattern to said structure; and
c) applying pressure to said caul member to place said caul member in juxtaposition with said metal or composite structure to be repaired, said pressure being insufficient to cause buckling.

15. In a method of manufacturing a metal or composite structure, such as a primary or secondary aircraft component, the improvement comprising:
a) providing a molding tool having a cavity and heat elements positioned in operative relationship relative to said molding tool for heating said molding tool,
b) providing a metal having superplastic properties lined relative to said cavity of said molding tool,
c) positioning a preformed composite material within said cavity of said molding tool,
d) heating said composite material uniformly to form a desired composite structure, and
e) removing said pressure and said formed composite structure from said molding tool.

16. The method of claim 14, wherein said heat is shaped heat that is conformed or defined by the shape of the heat spreader.

17. A method as defined in claim 16, wherein said heat is applied by applying perimeter heat to said layer of material and sequentially heating said perimeter and material internally of the perimeter of said layer of material.

18. A method as defined in claim 16, wherein the layer of material is applied to a component to be repaired, said layer of material being sized to overlap the perimeter area of the component to be repaired.

19. A method as defined in claim 16, wherein said layer of material comprises zinc or a zinc alloy.

20. A system for effecting a repair to a component having planar or complex geometries, the system comprising:
a sheet of a metal capable of exhibiting superplasticity, said sheet being adapted for positioning in an overlapping relationship over an area of said structure to be repaired;
a plurality of spaced apart heating means capable of applying non-uniform heat to said metal sheet, said heating means adapted to generate a substantially uniform heat within the part to be repaired;
pressure means adapted to apply pressure to said area and said metal for forcing said metal into juxtaposition with said area to be repaired, and
said heating means and said pressure means being adapted to deform said metal against said area to be repaired.

21. A system according to claim 20, wherein said sheet of metal selected from the group consisting of zinc, zinc alloys, aluminum.

22. A system according to claim 20, wherein said heating means includes a plurality of independently controllable heating members

23. A system according to claim 22, wherein said heating members are positionable to correspond to the geometry of the component to be repaired.

24. A system according to claim 22, wherein said heating members comprise temperature sensors

25. A system according to claim 21, wherein said heating members are operatively associated with said vacuum source

26. A system according to claim 20, wherein said pressure means is a vacuum pressure means or means for creating a pressurized atmosphere.
